(19) United States
(12) Patent Application Publication
(10) Pub. No.: US 2026/0049946 A1
(43) Pub. Date: Feb. 19, 2026

(54) WAFER DEFECT ANALYSIS DEVICE, SYSTEM INCLUDING THE SAME, AND WAFER DEFECT ANALYSIS METHOD

(71) Applicant: SAMSUNG ELECTRONICS CO., LTD., Suwon-si (KR)

(72) Inventors: Woohyuk BYEON, Suwon-si (KR); Jung-Hee Lee, Suwon-si (KR); Ghil-Geun Oh, Suwon-si (KR)

(73) Assignee: SAMSUNG ELECTRONICS CO., LTD., Suwon-si (KR)

(21) Appl. No.: 19/053,899

(22) Filed: Feb. 14, 2025

(30) Foreign Application Priority Data
Aug. 19, 2024 (KR) 10-2024-0110458

(51) Int. Cl. G01N 21/88; G01N 21/95; G06T 7/00

(52) U.S. Cl. CPC G01N 21/8851; G01N 21/9501; G06T 7/001; G01N 2021/8861; G06T 2207/20081; G06T 2207/20182

(57) ABSTRACT

A wafer defect analysis device may obtain manufacturing process data related to a manufacturing process of a reference wafer, generate reference wafer image data based on reference information according to a type of a wafer and the manufacturing process data, update a database based on a plurality of reference feature vectors extracted from the reference wafer image data using an artificial intelligence model, perform similarity analysis between a target feature vector extracted from target wafer image data of a target wafer and the plurality of reference feature vectors included in the updated database, and analyze a defect type of the target wafer based on a result of the similarity analysis.

### CROSS-REFERENCE TO RELATED APPLICATION

This application claims priority to and the benefit of Korean Patent Application No. 10-2024-0110458 filed at the Korean Intellectual Property Office on Aug. 19, 2024, the entire contents of which are incorporated herein by reference.

### BACKGROUND

### 1. Field

The present disclosure relates to a wafer defect analysis device, and more particularly, to a device, a system, and a method for analyzing a defect type of a wafer in a manufacturing process step of a semiconductor.

### 2. Description of the Related Art

A semiconductor device is manufactured through various processes. As semiconductor design technology develops, the number of processes for manufacturing a semiconductor, complexity of each process, or an integration degree of the semiconductor device is increasing. Accordingly, various defects or faults may occur in the semiconductor manufacturing process.

In order to identify and correct the defect or a cause of the defect of the semiconductor, a defect on a wafer of the semiconductor should be detected and types of the detected defects should be classified. Previously, the types of the defects were classified after testing of the wafer, and a supervised learning method or an unsupervised image clustering method were used for classifying the types of the defects of the wafer based on image labeling.

In this case, the image labeling is performed by a method for classifying the types of the defects based on previously known defect map types. In a case of the clustering, map types are classified by utilizing a cluster during an initial classification, and when a new type occurs, a final classification of the map types is performed by re-training a defect classification model using the new type. However, the method has a problem in which it takes a lot of time to learn each type of the defect. Additionally, it may be difficult to provide quick and accurate feedback on the defect of the wafer by classifying the types of the defects after the testing of the wafer.

### SUMMARY

One or more embodiments of the present disclosure provide a device, a system, and an operating method for more quickly and accurately determining a defect of a wafer by analyzing the defect of the wafer in a manufacturing process step of a semiconductor.

According to an aspect of the present disclosure, a wafer defect analysis device may include: a memory that stores reference information according to a type of a wafer, an artificial intelligence model configured to extract a feature vector from image data, and a database related to a defect type of the wafer; and at least one processor that is operationally connected to the memory and is configured to: obtain manufacturing process data related to a manufacturing process of a reference wafer; generate reference wafer image data based on the reference information and the manufacturing process data; update the database based on a plurality of reference feature vectors extracted from the reference wafer image data using the artificial intelligence model; perform similarity analysis between a target feature vector extracted from target wafer image data of a target wafer and the plurality of reference feature vectors included in the updated database; and analyze a defect type of the target wafer based on a result of the similarity analysis.

According to another aspect of the present disclosure, an operating method of a wafer defect analysis device may include: obtaining manufacturing process data related to a manufacturing process of a reference wafer; generating reference wafer image data based on reference information according to a type of a wafer and the manufacturing process data; updating a database based on a plurality of reference feature vectors extracted from the reference wafer image data using an artificial intelligence model configured to extract a feature vector from image data; performing similarity analysis between a target feature vector extracted from target wafer image data of a target wafer and the plurality of reference feature vectors included in the updated database; and analyzing a defect type of the target wafer based on a result of the similarity analysis.

According to another aspect of the present disclosure, a wafer defect analysis system may include: at least one measurement device configured to measure a reference wafer on which at least one unit process in semiconductor manufacturing is performed; and a wafer defect analysis device configured to analyze a defect type of a wafer based on manufacturing process data of the reference wafer received from the at least one measurement device, wherein the wafer defect analysis device may include at least one processor configured to: extract a feature vector from image data; generate reference wafer image data based on the manufacturing process data of the reference wafer; extract a plurality of reference feature vectors related to a defect of the reference wafer from the reference wafer image data, using an artificial intelligence model; and perform similarity analysis between a target feature vector extracted from target wafer image data of a target wafer and the plurality of reference feature vectors; and analyze a defect type of the target wafer based on a result of the similarity analysis.

According to embodiments of the present disclosure, rapid feedback on a defect of a wafer may be provided by predicting a defect type of the wafer using manufacturing process data of the wafer before testing of the wafer.

### BRIEF DESCRIPTION OF THE DRAWINGS

FIG. 1 is a view for describing a wafer defect analysis system according to one or more embodiments.

FIG. 2 is a block diagram of a wafer defect analysis device according to one or more embodiments.

FIG. 3 is a flowchart showing an operating method of the wafer defect analysis device according to one or more embodiments.

FIG. 4 is a view for describing an operation of a processor according to one or more embodiments.

FIG. 5 is a view for describing an operation of a model learning module according to one or more embodiments.

FIG. 6 is a view for describing an operation of a feature vector extraction module according to one or more embodiments.

FIG. 7 is a view for describing an operation of a similarity calculation module according to one or more embodiments.

FIG. 8 is a view for describing a similarity calculation method of the similarity calculation module according to one or more embodiments.

FIG. 9 is a view for describing that the wafer defect analysis device according to the one or more embodiments provides a defect analysis result.

FIG. 10 is a view for describing that the wafer defect analysis device according to the one or more embodiments transmits a database to the outside.

FIG. 11 is a view showing an example of a computer device implementing the wafer defect analysis device according to one or more embodiments.

### DETAILED DESCRIPTION

Embodiments of the present disclosure will be described more fully hereinafter with reference to the accompanying drawings so that those skilled in the art can easily implement the embodiments. The present disclosure may be modified in various ways, all without departing from the spirit or scope of the present disclosure.

In order to clearly describe the present disclosure, parts or portions that are irrelevant to the description are omitted, and identical or similar constituent elements throughout the specification are denoted by the same reference numerals.

Hereinafter, terms such as a map and a reference map are used to concisely and clearly describe embodiments of the present disclosure. The term “map” used in the specification may include data or information in which various information measured from a semiconductor wafer is provided in a form of an image. One map may be information corresponding to one semiconductor wafer. That is, the one map may be generated based on results of various tests on the one semiconductor wafer. The term “map” used in the specification may be used interchangeably with the terms such as “wafer map” and “wafer image data”.

The term “target map” used in the specification may refer to data or information that is an object of defect analysis of the semiconductor wafer.

Additionally, the term “target vector” used in the specification may refer to a feature vector extracted from a target map that is the object of the defect analysis of the semiconductor wafer.

The term “reference map” used in the specification may refer to a map that is related to a defect type of the wafer to be stored in a database, and may refer to data or information that is compared with the target map in the defect analysis of the semiconductor wafer. That is, the reference map may include maps including the defect among maps measured from various semiconductor wafers. Each reference map may be managed together with information on a defect type corresponding to each reference map.

Additionally, the term “reference vector” used in the specification may refer to a feature vector that is related to a defect type of the wafer to be stored in a database, and may refer to data or information that is compared with the target vector in the defect analysis of the semiconductor wafer. The reference vector may include a feature vector extracted from maps including the defect among maps measured from various semiconductor wafers. The reference vector may be considered a label or ground truth value used in training a machine learning model to minimize a loss, which may represent a difference between the model's predictions and the label (or ground truth). Each reference vector may be managed together with information on a defect type corresponding to each reference vector.

A database of the reference map (or the reference vector) managed or generated by a wafer defect analysis device described below may be used to perform the defect analysis of the semiconductor wafer. For example, the database may include one or more reference maps (or one or more reference vectors) for each of various defect types of the semiconductor wafer, and may be used to classify or analyze the defect type corresponding to the target map (or the target vector) by detecting the reference map (or the reference vector) matching or similar to the target map (or the target vector) in a defect analysis operation of the wafer.

Hereinafter, embodiments of the present disclosure are described in more detail with reference to the attached drawings. However, the scope of the present disclosure is not limited thereto.

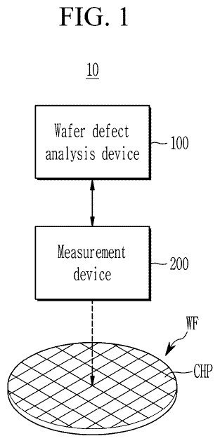

FIG. 1 is a view for describing a wafer defect analysis system 10 according to one or more embodiments.

Referring to FIG. 1, the wafer defect analysis system 10 according to the embodiment may include a measurement device 200 that measures a wafer WF during a manufacturing process of the wafer to output manufacturing process data of the wafer, and the wafer defect analysis device 100 that analyzes a defect of the wafer based on the manufacturing process data received from the measurement device 200.

The wafer WF may be used as a substrate for a semiconductor. For example, the wafer WF may include a material having a semiconductor characteristic such as silicon (Si) or gallium arsenide (GaAs). The wafer WF may have various semiconductor patterns according to a process.

The wafer WF may include one or more semiconductor chips CHP. The semiconductor chip CHP may be a memory chip or a non-memory chip. The memory chip may be a non-volatile memory chip or a volatile memory chip. The memory chip may include a cell region and a peripheral region. The cell region may include a plurality of memory cells. The plurality of memory cells may be disposed where a plurality of bit lines and a plurality of word lines intersect. The plurality of memory cells may be included in a plurality of memory blocks. The peripheral region may include components other than the cell region in the memory chip. For example, a peripheral region of the non-volatile memory chip may include a control logic, a page buffer, a row decoder, a voltage generator, and the like. As another example, a peripheral region of the volatile memory chip may include a control logic, a row decoder, a column decoder, a sense amplifier, a refresh control logic, a bank control logic, and the like. The non-memory chip may further include a memory chip. In the present disclosure, the chip may also be referred to as a die.

According to an embodiment, the measurement device 200 may perform actual measurement (or measurement) of the wafer WF at a manufacturing process step of the wafer. According to an embodiment, the measurement device 200 may measure the wafer WF on which at least one unit process is performed. The term “unit process” may refer to to an individual step or operation (e.g., deposition, etching, doping, photolithography, etc.) that is part of the overall semiconductor manufacturing process. According to an embodiment, the measurement device 200 may monitor the wafer WF in the manufacturing process step of the wafer WF to output the manufacturing process data.

According to an embodiment, the measurement device 200 may include at least one measurement apparatus. For example, the measurement device 200 may include a first measurement apparatus measuring the wafer WF on which a first manufacturing process (e.g., deposition) is performed, and a second measurement device measuring the wafer WF on which a second manufacturing process (e.g., etching) is performed after the first manufacturing process is performed.

If there are a plurality of wafers WF, the measurement device 200 may measure a characteristic of the wafer WF for each wafer WF. According to an embodiment, the measurement device 200 may measure the characteristic of the wafer WF by radiating light onto the wafer WF. For example, the measurement device 200 may perform optical critical dimension (OCD) measurement, electron beam (e-beam) measurement, x-ray measurement, device characteristic measurement, and the like.

According to an embodiment, the measurement device 200 may measure the wafer WF to output the manufacturing process data.

The manufacturing process data may be data generated in each process of a time sequential manufacturing process, and for example, may be provided in a form of a log, a map, a table, or a list, but the present disclosure is not necessarily limited thereto. For example, the manufacturing process data may include at least one of sensing data, spec data, and virtual measurement data related to the manufacturing process for at least one of an operating state of a manufacturing facility, a phenomenon indicated by the manufacturing facility, and an output of the manufacturing facility occurring in a process in which the manufacturing facility performs the time sequential manufacturing process, but the present disclosure is not necessarily limited thereto.

For example, the spec data may be data indicating an upper limit and/or a lower limit of sensing data of sensors. The spec data may also be referred to as operation condition data.

For example, the manufacturing process data may be fault detection & classification (FDC) data and/or virtual metrology (VM) data, but the present disclosure is not necessarily limited thereto. The FDC data may be result data in which fault of the manufacturing facility is detected in real time and monitored by monitoring and analyzing sensor data of the manufacturing facility in real time in a semiconductor manufacturing industry to detect abnormality of the process and identify the abnormality.

The VM data may be data according to a big data technique that may be applied in the manufacturing process, and may correspond to a measurement value predicted using the sensor data of the manufacturing facility generated in the manufacturing process. The VM data may be used for monitoring the manufacturing process, and data that deviates from homeostasis among the VM data may be detected as an abnormal phenomenon.

In the present disclosure, the manufacturing process data may be understood to include coordinate information of the die included in the wafer WF and defect coordinate information in which a defect within the die is disposed.

According to an embodiment, the measurement device 200 may measure the wafer WF on which at least one unit process is performed to output the manufacturing process data in real time.

According to an embodiment, the measurement device 200 may provide the manufacturing process data to the wafer defect analysis device 100. For example, the measurement device 200 may transmit the manufacturing process data to the wafer defect analysis device 100 in real time.

According to an embodiment, the wafer defect analysis device 100 may correspond to a computing device such as a server, a personal computer, a laptop, a portable communication terminal, or a smart phone.

According to an embodiment, the wafer defect analysis device 100 may receive the manufacturing process data from the measurement device 200. The wafer defect analysis device 100 may inspect the wafer WF using the manufacturing process data. The wafer defect analysis device 100 may quickly select a semiconductor chip having a potential defect risk by analyzing a defect of the wafer WF in the manufacturing process step.

As described above, the wafer defect analysis device 100 according to the present disclosure may accurately identify a defect-causing factor occurring in the manufacturing process step by analyzing the defect of the wafer WF using the time sequential manufacturing process data.

In addition, as described above, the wafer defect analysis device 100 according to the present disclosure may quickly improve the process by analyzing the defect of the wafer WF using the manufacturing process data to identify a defect type of the wafer before testing of the wafer.

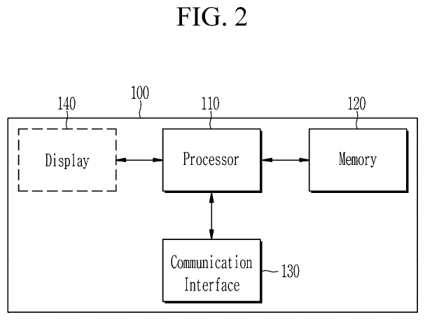

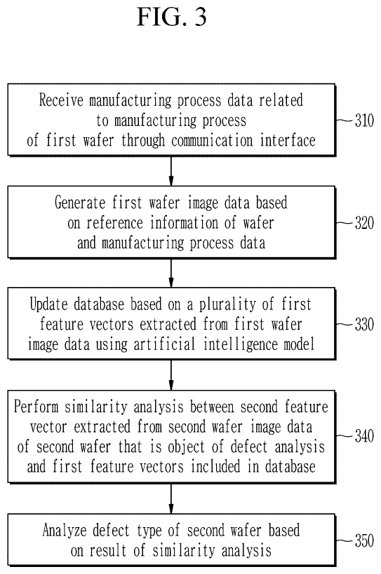

A detailed description of a component and an operating method of the wafer defect analysis device 100 is provided below with reference to FIG. 2 and FIG. 3.

FIG. 2 is a block diagram of the wafer defect analysis device 100 according to one or more embodiments.

Referring to FIG. 2, the wafer defect analysis device 100 according to the embodiment may include at least one processor 110, a memory 120, and a communication interface 130. According to an embodiment, the wafer defect analysis device 100 may further include a display 140. In some embodiments, the wafer defect analysis device 100 may omit at least one of the components described above, or may additionally include another component.

According to an embodiment, the at least one processor 110 may be operatively connected to the memory 120, the communication interface 130, and/or the display 140. The processor 110 may control an operation of the wafer defect analysis device 100 by controlling at least one other component of the wafer defect analysis device 100 connected to the processor 110.

According to an embodiment, the processor 110 may control an overall operation of the wafer defect analysis device 100. The processor 110 may include an accelerator that is a dedicated circuit for data calculation. The accelerator may be a functional block that professionally performs a specific function of the processor 110. The accelerator may include a graphics processing unit (GPU), a neural processing unit (NPU), or a data processing unit (DPU). The GPU may be a block for professionally processing graphics data. The NPU may be a block for professionally performing artificial intelligence (AI) calculation and inference. The DPU may be a block for professionally performing data transmission.

According to an embodiment, the processor 110 may execute instructions stored in the memory 120. The processor 110 may execute applications stored in the memory 120. Each application may be a set of instructions. The processor 110 may execute the instructions stored in the memory 120 to allow the wafer defect analysis device 100 to perform operations described below. Operations described below as being performed by the processor 110 may be performed by the processor 110 and/or at least one other component of the wafer defect analysis device 100 connected to the processor 110, so that the operations described below may be understood to be performed by the wafer defect analysis device 100.

According to an embodiment, the memory 120 may store data used or received by at least one component (e.g., the processor 110 or the communication interface 130) of the wafer defect analysis device 100. The memory 120 may store instructions executed by the at least one processor 110.

According to an embodiment, the memory 120 may include instructions for executing a method for testing a plurality of semiconductor chips according to a plurality of test items. Additionally, the memory 120 may store instructions for executing a method for selecting the semiconductor chip with the potential defect risk from an inspected wafer WF. The instructions may be stored in the memory 120 as a code of a computer program.

According to an embodiment, the memory 120 may store coordinate system data for calculating a position of the wafer WF and/or the semiconductor chip CHP. The coordinate system data may include the wafer map corresponding to the wafer WF.

According to an embodiment, the memory 120 may store reference information according to a type of the wafer. The reference information may serve as a reference or baseline for understanding a structure and defect locations of a semiconductor wafer or chip. In the present disclosure, the reference information may vary according to the type of the wafer (or a type of a semiconductor product), and may include coordinate information of the chip included in the wafer. The coordinate information of the chip may include spatial locations of individual chips (or dies) on a wafer, and may specify where each chip is positioned relative to the entire wafer. The reference information may also include defect coordinate information in which a defect within the chip of the wafer is disposed. The defect coordinate information may include locations of any known or expected defects within the individual chips on the wafer, wherein these defects may be identified based on the wafer type and the typical defect patterns associated with that type of wafer or semiconductor product. If a specific type of wafer is known to frequently have defects near the edge of chips, the reference information may include defect locations (e.g., defect coordinate (x=20, y=18) on chip #20), which indicates where a defect has been detected in the past or is expected. The reference information according to the type of the wafer may be previously stored in the memory 120. The reference information may include a reference map and a reference vector, or the reference map and the reference vector may be generated or derived from the reference information.

According to an embodiment, the memory 120 may store one or more artificial intelligence models (or one or more neural network models) and a learning data set. The one or more artificial intelligence models may include an artificial intelligence model that performs learning extracting a data characteristic from input data among various learning methods such as deep learning and machine learning.

According to an embodiment, the one or more artificial intelligence models may include an artificial intelligence model learned to extract a feature vector from learning data. For example, the artificial intelligence model may include an auto-encoder model that includes a plurality of encoders and a plurality of decoders.

The auto-encoder model may be a deep learning artificial intelligence model, including the encoder that reduces data input to the model into a low-dimensional space and the decoder that restores the reduced data back to a dimension of the input data.

The learning data set may be a set used to train the artificial intelligence model. For example, the learning data set may include the wafer map (or the wafer image data).

In the present disclosure, the wafer map may refer to data or information in which various information measured from the semiconductor wafer is provided in a form of the image. For example, the wafer map may include coordinate information of the chip included in the wafer and defect coordinate information in which a defect within the chip of the wafer is disposed.

According to an embodiment, the memory 120 may store a database related to a defect type of the wafer. For example, the memory 120 may store a database including feature vectors extracted by the artificial intelligence model. According to an embodiment, the database stored in the memory 120 may be an object for which the processor 110 performs similarity analysis with the target vector of the target map that is an object of the defect analysis.

According to an embodiment, the memory 120 may store data transmitted and received through the communication interface 130. For example, the memory 120 may store manufacturing process data received through the communication interface 130.

According to an embodiment, the manufacturing process data may be obtained from an external electronic device (e.g., the measurement device 200), a server, a web storage, or an external storage device (e.g., an external database or an external memory card) through the communication interface 130 to be stored in the memory 120.

According to an embodiment, the memory 120 may store the manufacturing process data obtained from at least one measurement device (e.g., the measurement device 200 of FIG. 1).

For example, the memory 120 may include first manufacturing process data obtained by measuring the wafer WF on which the first manufacturing process is performed, and second manufacturing process data obtained by measuring the wafer WF on which the second manufacturing process is performed after the first manufacturing process is performed.

In some embodiments, the memory 120 may be implemented as a non-volatile memory such as a read-only memory (ROM), a magnetic memory (MRAM), a spin transfer torque MRAM, a conductive bridging RAM (CBRAM), a ferroelectric RAM (FeRAM), a phase RAM (PRAM), or a resistive RAM. However, the present disclosure is not limited thereto.

In other embodiments, the memory 120 may be implemented as a volatile memory such as a dynamic random access memory (DRAM), a synchronous DRAM (SDRAM), a double data rate SDRAM (DDR SDRAM), a low power double data rate SDRAM (LPDDR SDRAM), a graphics double data rate SDRAM (GDDR SDRAM), a DDR2 SDRAM, a DDR3 SDRAM, a DDR4 SDRAM, or a DDR5 SDRAM. However, the present disclosure is not limited thereto.

According to an embodiment, the communication interface 130 may support establishing a wired or wireless communication channel between the wafer defect analysis device 100 and the external electronic device (e.g., the measurement device 200) and performing communication through the established communication channel. According to an embodiment, the processor 110 may obtain the manufacturing process data from a cloud server, the web storage, or the external storage device (e.g., the external database or the external memory card) through the communication interface 130. The communication interface may 130 be implemented by any one or any combination of a digital modem, a radio frequency (RF) modem, an antenna circuit, a WiFi chip, and related software and/or firmware.

According to an embodiment, the processor 110 may receive the manufacturing process data obtained in a manufacturing process of the semiconductor wafer from the external electronic device (e.g., the measurement device 200) through the communication interface 130.

According to an embodiment, the processor 110 may transmit a database related to a defect type of the wafer to at least one of an external electronic device, a server, and a cloud computing system through the communication interface 130. Specifically, the processor 110 may extract a plurality of feature vectors from the wafer map using an artificial intelligence model, and may transmit a database updated based on the extracted feature vectors to at least one of the external electronic device, the server, and the cloud computing system.

According to an embodiment, the communication interface 130 may include a wireless communication interface (e.g., a cellular communication interface, a short-range wireless communication interface, or a global navigation satellite system (GNSS) communication interface) or a wired communication interface (e.g., a local area network (LAN) communication interface or a power line communication interface).

According to an embodiment, the processor 110 may use the communication interface 130 to communicate with an external electronic device via a first network (e.g., a short-range communication network such as Bluetooth, WiFi direct, or IrDA) or a second network (e.g., a long-range communication network such as a cellular network, the Internet, or a computer network (e.g., a LAN or a WAN)). Various types of communication interfaces 130 described above may be implemented as one chip or as separate chips.

According to an embodiment, the display 140 may display information processed by the display 140 under control of the processor 110. For example, the display 140 may display various contents (e.g., a text, an image, a video, an icon, and/or a symbol). According to an embodiment, the display 140 may include a liquid crystal display (LCD), a light-emitting diode (LED) display, or an organic light-emitting diode (OLED) display.

According to an embodiment, the display 140 may include a touch screen, and may receive a touch, a gesture, proximity, or a hovering input using an electronic pen or a portion of a user's body. In this case, the display 140 may also be used as an input device, but the present disclosure is not limited thereto. In some embodiments, the wafer defect analysis device 100 may include a separate input device.

According to an embodiment, the display 140 may visually provide various information to a user (e.g., a worker) of the wafer defect analysis device 100. According to an embodiment, the display 140 may display a content related to an input of the user in response to receiving the input of the user.

According to an embodiment, the display 140 may display data processed by the processor 110. According to an embodiment, if a defect type of the wafer for the target map that is an object of defect type analysis by the processor 110 is determined, the display 140 may display information on the determined defect type of the wafer. Specifically, the display 140 may display the reference maps within the database aligned (or listed) in an order in which the reference maps are similar to the target map.

According to an embodiment, the display 140 may display a graphical user interface (GUI) indicating an analysis result. For example, the display 140 may display the GUI indicating a result of aligning the reference maps within the database stored in the memory 120 in an order in which the reference maps are similar to the target map.

FIG. 3 is a flowchart showing the operating method of the wafer defect analysis device according to one or more embodiments.

Each operation in FIG. 3 may be sequentially performed, but is not necessarily performed sequentially. For example, an order of operations of FIG. 3 may be changed, and at least two operations may be performed in parallel. In some embodiments, some of the operations shown in FIG. 3 may be omitted, some of the operations may be integrated, an order of some of the operations may be changed, or another operation may be added.

Referring to FIG. 3, in an operation (or a step) 310, a processor according to an embodiment (e.g., the processor 110 of FIG. 2) may receive manufacturing process data related to a manufacturing process of a first wafer through a communication interface (e.g., the communication interface 130 of FIG. 2). The first wafer may serve as a reference wafer, providing information to estimate a defect type of a target wafer undergoing defect type identification. The target wafer may be also referred to as a second wafer in the present disclosure.

In the present disclosure, the first wafer may be understood as a concept including a plurality of semiconductor wafers, and first wafer image data may be understood as a concept including all wafer image data of the plurality of semiconductor wafers.

For example, the first wafer may include n wafers (wherein n is a natural number), and the first wafer image data may include all wafer image data of the n wafers.

According to an embodiment, the processor 110 may receive the manufacturing process data related to the manufacturing process of the first wafer from a measurement device (e.g., the measurement device 200 of FIG. 1) through the communication interface 130.

According to an embodiment, the processor 110 may receive the manufacturing process data from the measurement device 200 in real time during the manufacturing process of the first wafer. In other words, the processor 110 may receive the manufacturing process data output by the measurement device 200 monitoring the first wafer during the manufacturing process of the first wafer in real time.

According to an embodiment, the processor 110 may receive the manufacturing process data of the wafer on which at least one manufacturing process is performed from the measurement device 200. For example, the processor 110 may receive first manufacturing process data obtained by measuring the first wafer on which a first manufacturing process is performed. Additionally, for example, the processor 110 may receive second manufacturing process data obtained by measuring the first wafer on which a second manufacturing process is performed after the first manufacturing process is performed. Here, the first manufacturing process data may be output by a first measurement device, and the second manufacturing process data may be output by a second measurement device that is different from the first measurement device.

For example, the manufacturing process data may include coordinate information of a die included in the first wafer and defect coordinate information in which a defect within the die is disposed.

In an operation 320, the processor 110 according to the embodiment may generate the first wafer image data based on reference information of the wafer and the manufacturing process data.

According to an embodiment, the processor 110 may convert the manufacturing process data into the first wafer image data (or a first wafer map) based on pre-stored reference information of the wafer.

According to an embodiment, the processor 110 may generate the first wafer image data by normalizing the manufacturing process data. For example, Min-Max Scaling may be used as the normalization method.

Min-Max Scaling may be used as a method for normalizing the manufacturing process data regardless of a type of a semiconductor wafer product.

For example, the processor 110 may generate the first wafer image with a reference size by normalizing the manufacturing process data of the first wafer. For example, the reference size may be a size of 224×224×3. When the normalization is performed on the manufacturing process data, the pre-stored reference information of the wafer may be used according to a type of the semiconductor wafer.

According to an embodiment, the processor 110 may use an X coordinate (X_{chip}) of a chip (or a die) included in the first wafer and an X defect coordinate (X_{defect}) at which a defect is disposed within the chip (or the die) that are included in the manufacturing process data to calculate an X defect coordinate (X_{Wafer}) at which a defect is disposed within the first wafer based on Equation 1.

$${X}_{wafer} = ( {X}_{chip} - min ( {X}_{chip} ) + \frac{{x}_{defect}}{max ( {X}_{defect} )} ) \times \frac{224}{( max ( {x}_{chip} ) - min ( {x}_{chip} ) )} \qquad ( Equation l )$$

According to an embodiment, the processor 110 may use a Y coordinate (Y_{chip}) of the chip (or the die) included in the first wafer and a Y defect coordinate (Y_{defect}) at which a defect is disposed within the chip (or the die) that are included in the manufacturing process data to calculate a Y defect coordinate (Y_{Wafer}) at which a defect is disposed within the first wafer based on Equation 2.

$${Y}_{wafer} = ( {Y}_{chip} - min ( {Y}_{chip} ) + \frac{{Y}_{defect}}{max ( {Y}_{defect} )} ) \times \frac{224}{( max ( {Y}_{chip} ) - min ( {Y}_{chip} ) )} \qquad ( Equation 2 )$$

According to an embodiment, the processor 110 may generate the first wafer image data based on a result of performing the normalization. In other words, the processor 110 may generate the first wafer image data based on the X defect coordinate (X_{Wafer}) at which the defect is disposed within the first wafer and the Y defect coordinate (Y_{Wafer}) at which the defect is disposed within the first wafer.

In an operation 330, the processor 110 according to the embodiment may update the database based on a plurality of first feature vectors extracted from the first wafer image data using an artificial intelligence model.

The processor 110 according to the embodiment may train the artificial intelligence model using the first wafer image data as learning data.

Here, the artificial intelligence model may be trained to extract a feature vector from the learning data. For example, the artificial intelligence model may include an auto-encoder model that includes a plurality of encoders and a plurality of decoders.

The auto-encoder model may be a deep learning model, and may mean an artificial intelligence model including the encoder that reduces data input to the model into a low-dimensional space and the decoder that restores the reduced data back to a dimension of the input data.

According to an embodiment, the processor 110 may remove a noise from the first wafer image data using a density-based spatial clustering with applications (DBSCAN) algorithm. According to an embodiment, the processor 110 may remove a noise from the first wafer image data to use the first wafer image data from which the noise is removed as learning data for training the artificial intelligence model.

As described above, the wafer defect analysis device 100 according to the present disclosure may accurately extract information related to the defect type by performing a noise removal operation on the learning data for learning the artificial intelligence model.

According to an embodiment, the processor 110 may extract (or generate) the first feature vector from the first wafer image data using the trained artificial intelligence model. According to an embodiment, if the first wafer image data includes data for a plurality of wafers, the processor 110 may extract the plurality of first feature vectors using the trained artificial intelligence model.

According to an embodiment, the first feature vector may indicate whether the first wafer is defective. Each of the plurality of first feature vectors may indicate whether each of a plurality of first wafers is defective. However, the embodiment of the present disclosure is not limited thereto, and the first feature vector may include a plurality of semiconductor element characteristics of the wafer.

According to an embodiment, the processor 110 may update the database based on the first feature vector extracted from the first wafer image data. Specifically, the processor 110 may update the database that is related to a defect type of the wafer based on the first feature vector to be previously stored in the memory 120.

In the present disclosure, the first feature vector may be referred to as the reference vector that is related to the defect type of the wafer to be stored in the database.

The first feature vector (or the reference vector) stored in the database may be an object that is compared with a second feature vector (or the target vector) in the defect analysis of the wafer described later.

That is, the first feature vector may include data for wafers that include defects among the measured wafers. Each first feature vector may be managed together with information on the defect type corresponding thereto.

As described above, accuracy and reliability of the defect analysis of the wafer may be improved by using the updated database of the wafer defect analysis device 100 according to the present disclosure.

In an operation 340, the processor 110 according to the embodiment may perform similarity analysis between the second feature vector extracted from second wafer image data of a second wafer that is an object of the defect analysis and the first feature vectors included in the database.

According to an embodiment, the processor 110 may obtain the second wafer image data of the second wafer that is the object of the defect analysis. For example, the processor 110 may obtain the second wafer image data from a cloud server, a web storage, or an external storage device (e.g., an external database or an external memory card), but the present disclosure is not limited thereto. For example, the second wafer image data may include test image data of the wafer on which testing of the wafer is completed.

According to an embodiment, the processor 110 may extract (or generate) the second feature vector from the second wafer image data using the artificial intelligence model. For example, the processor 110 may extract the second feature vector from the second wafer image data using the auto-encoder model.

According to an embodiment, the processor 110 may perform the similarity analysis between the second feature vector and the first feature vector included in the database. The processor 110 may perform the similarity analysis between the second feature vector and the plurality of first feature vectors included in the database.

According to an embodiment, the processor 110 may calculate a similarity between the second feature vector and the first feature vector based on a variable of the second feature vector and a variable of the first feature vector.

According to an embodiment, the processor 110 may determine that the similarity between the second feature vector and the first feature vector is greater as the variable of the second feature vector and the variable of the first feature vector are similar to each other. Additionally, the processor 110 may determine that a similarity between the second wafer image and the first wafer image is greater as the second feature vector and the first feature vector are similar to each other.

According to an embodiment, the processor 110 may calculate a distance between the second feature vector and the first feature vector and/or a cosine similarity between the second feature vector and the first feature vector based on the variable of the second feature vector and the variable of the first feature vector.

For example, the processor 110 may calculate the distance between the second feature vector and the first feature vector based on the variable of the second feature vector and the variable of the first feature vector. According to an embodiment, the processor 110 may determine that the similarity between the second feature vector and the first feature vector is greater as the distance between the second feature vector and the first feature vector is smaller.

In addition, for example, according to an embodiment, the processor 110 may calculate the cosine similarity between the second feature vector and the first feature vector based on the variable of the second feature vector and the variable of the first feature vector. According to an embodiment, the processor 110 may determine that the cosine similarity between the second feature vector and the first feature vector is greater as the variable of the second feature vector and the variable of the first feature vector are similar. According to an embodiment, the processor 110 may determine that the similarity between the second wafer image and the first wafer image is greater as the cosine similarity between the second feature vector and the first feature vector is greater.

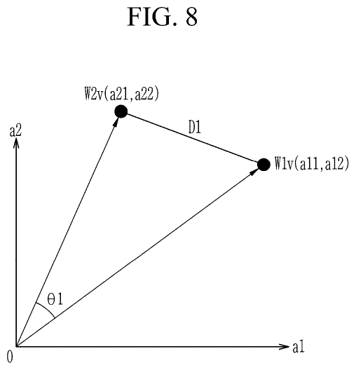

Specific details regarding calculation of the similarity between the first feature vector and the second feature vector will be described later with reference to FIG. 8.

In an operation 350, the processor 110 according to the embodiment may analyze a defect type of the second wafer based on a result of the similarity analysis.

According to an embodiment, the processor 110 may analyze the similarity between the first feature vector and the second feature vector to quantify the similarity. The processor 110 may analyze the similarity between the second feature vector and each of the plurality of first feature vectors included in the database to quantify each similarity.

For example, it may be determined that the first feature vector and the second feature vector are similar as a value of the similarity is higher.

According to an embodiment, the processor 110 may align the first feature vectors in an order in which the similarity between the first feature vector and the second feature vector is large based on a weighting function set to identify a higher ranking as the value of the similarity is higher.

According to an embodiment, the processor 110 may provide analysis result data obtained by aligning the first feature vectors in the order in which the similarity between the first feature vector and the second feature vector is large. For example, the analysis result data may be provided in a form of a log, a map, a table, or a list, but the present disclosure is not necessarily limited thereto.

According to an embodiment, the processor 110 may remove the first feature vector that is determined to have a low similarity among the analysis result data.

For example, the first feature vector having a similarity less than or equal to a predetermined threshold value may be removed from the analysis result data. Alternatively, for example, the first feature vector having a similarity ranking less than or equal to a predetermined threshold ranking may be removed from the analysis result data.

More specifically, for example, if the analysis result data is provided in the form of the list, the first feature vector having the similarity less than or equal to the predetermined threshold value may be removed from the list. In addition, more specifically, for example, if the analysis result data is provided in the form of the list, the first feature vector having the similarity ranking less than or equal to the predetermined threshold ranking may be removed from the list.

According to an embodiment, the processor 110 may cluster the plurality of first feature vectors aligned in the order in which the similarity is large into a plurality of clusters using a K-means clustering method. For example, the first feature vectors included in one cluster may have similarities similar to each other.

For example, the processor 110 may cluster the plurality of first feature vectors aligned in the order in which the similarity is large into five clusters using the K-means clustering method. Specifically, for example, if 15 first feature vectors are clustered into five clusters, three first feature vectors included in one cluster may have similar similarities similar to each other.

As described above, the wafer defect analysis device 100 according to the present disclosure may improve convenience of a user analyzing the defect type by clustering the plurality of first feature vectors using the K-means clustering method.

According to an embodiment, the processor 110 may display a graphical user interface (GUI) indicating the result of the similarity analysis via a display (e.g., the display 140 of FIG. 2).

For example, the processor 110 may provide the analysis result data in a form of an image (or a map) through the display 140. In other words, the processor 110 may provide first wafer images in the order in which the similarity is large through the display 140.

Additionally, for example, the processor 110 may display a GUI indicating a result of clustering the plurality of first feature vectors aligned in the order in which the similarity is large via the display 140.

According to an embodiment, the processor 110 may analyze the defect type of the second wafer based on the analysis result data.

According to an embodiment, the processor 110 may identify a defect type of the first wafer image that is determined to have the highest similarity based on the analysis result data.

According to an embodiment, the processor 110 may determine that the defect type identified in the first wafer image that is determined to have the highest similarity is the same as the defect type of the second wafer.

As described above, the wafer defect analysis device 100 according to the present disclosure may provide rapid feedback on the defect of the wafer by analyzing the defect type of the wafer using the manufacturing process data before testing of the wafer.

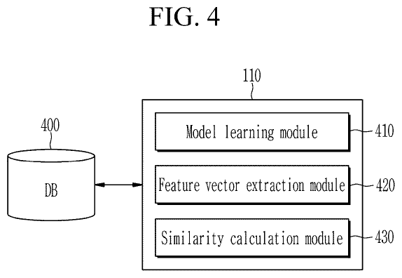

FIG. 4 is a view for describing an operation of the processor according to one or more embodiments.

In the present disclosure, contents in which the processor 110 performs the defect analysis of the wafer using a database 400 may be similar to those described above with reference to FIG. 3, so that they may be simplified or omitted.

Referring to FIG. 4, the processor 110 according to the embodiment may include a model learning module 410, a feature vector extraction module 420, and a similarity calculation module 430. In some embodiments, the processor 110 may omit at least one of the components described above, or may additionally include another component.

According to an embodiment, the model learning module 410 may learn the artificial intelligence model to extract the feature vector from the learning data. For example, the model learning module 410 may train the auto-encoder model that includes the plurality of encoders and the plurality of decoders.

The auto-encoder model may be a deep artificial intelligence learning model, including the encoder that reduces data input to the model into a low-dimensional space and the decoder that restores the reduced data back to a dimension of the input data.

According to an embodiment, the model learning module 410 may receive the first wafer image data generated by normalizing the manufacturing process data.

According to an embodiment, the model learning module 410 may train the artificial intelligence model to extract the feature vector using the received first wafer image data as the learning data.

According to an embodiment, the model learning module 410 may receive a latest first wafer image data every specific period (or every specific number of times) to train the artificial intelligence model. Accordingly, the wafer defect analysis device 100 according to the present disclosure may improve reliability of the defect analysis by including the artificial intelligence model that learns the latest wafer.

According to an embodiment, the feature vector extraction module 420 may extract the feature vector from the wafer image data using the artificial intelligence model trained by the model learning module 410.

According to an embodiment, if the wafer image data includes data for a plurality of wafers, the feature vector extraction module 420 may extract a plurality of feature vectors using the trained artificial intelligence model.

According to an embodiment, the extracted feature vector may indicate whether the wafer is defective. Each of the plurality of feature vectors may indicate whether each of the plurality of wafers is defective. However, the embodiment of the present disclosure is not limited thereto, and the feature vector may include a plurality of semiconductor element characteristics of the wafer.

According to an embodiment, the database 400 may be updated based on the feature vector extracted from the wafer image data by the feature vector extraction module 420. Specifically, the database 400 related to the defect type of the wafer may be updated based on the feature vector extracted by the feature vector extraction module 420.

According to an embodiment, the database 400 may be updated every specific period (or every specific number of times).

As described above, the wafer defect analysis device 100 according to the present disclosure may improve accuracy and reliability of the defect analysis of the wafer using the database 400 that is updated every specific period (or every specific number of times).

The updated database 400 may include feature vectors for wafers that include defects among the measured wafers. Each feature vector may be managed together with information on the defect type corresponding thereto.

In the present disclosure, the feature vector included in the updated database 400 may be referred to as the reference vector.

According to an embodiment, the feature vector extraction module 420 may extract the feature vector from the image data of the wafer that is the object of the defect analysis. In the present disclosure, the feature vector extracted from the image data of the wafer that is the object of the defect analysis may be referred to as the target vector.

According to an embodiment, the feature vector extraction module 420 may extract the target vector from the wafer image data obtained from a cloud server, a web storage, or an external storage device (e.g., an external database or an external memory card).

According to an embodiment, the feature vector extraction module 420 may extract the target vector from the wafer image data using the trained artificial intelligence model. For example, the feature vector extraction module 420 may extract the target vector from the wafer image data using the auto-encoder model.

According to an embodiment, the similarity calculation module 430 may perform similarity analysis between the target vector of the wafer that is the object of the defect analysis and the reference vector included in the database. The similarity calculation module 430 may perform similarity analysis between the target vector and a plurality of reference vectors included in the database.

According to an embodiment, the similarity calculation module 430 may calculate a similarity between the target vector and the reference vector based on a variable of the target vector and a variable of the reference vector.

According to an embodiment, the similarity calculation module 430 may determine that the similarity between the target vector and the reference vector is greater as the variable of the target vector and the variable of the reference vector are similar to each other.

For example, the similarity calculation module 430 may calculate a distance between the target vector and the reference vector based on the variable of the target vector and the variable of the reference vector. According to an embodiment, the similarity calculation module 430 may determine that the similarity between the target vector and the reference vector is greater as the distance between the target vector and the reference vector is smaller.

In addition, for example, according to an embodiment, the similarity calculation module 430 may calculate a cosine similarity between the target vector and the reference vector based on the variable of the target vector and the variable of the reference vector. According to an embodiment, the similarity calculation module 430 may determine that the cosine similarity between the target vector and the reference vector is greater as the variable of the target vector and the variable of the reference vector are similar.

According to an embodiment, the similarity calculation module 430 may analyze the similarity between the reference vector and the target vector to quantify the similarity. The similarity calculation module 430 may analyze the similarity between the target vector and each of the plurality of reference vectors included in the database to quantify each similarity.

For example, it may be determined that the reference vector and the target vector are similar as a value of the similarity is higher.

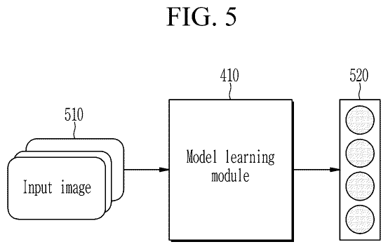

FIG. 5 is a view for describing an operation of the model learning module 410 according to one or more embodiments.

Referring to FIG. 5, the model learning module 410 according to the embodiment may train the artificial intelligence model to extract the feature vector using an input image 510 as the learning data.

The input image 510 may include the wafer image data generated by normalizing the manufacturing process data. For example, the input image 510 may include the wafer image data having a size of 224×224×3.

According to an embodiment, the model learning module 410 may learn the auto-encoder model that includes the plurality of encoders and the plurality of decoders.

According to an embodiment, the auto-encoder model may extract a feature vector 520 corresponding to the input image 510 by performing encoding (or compression) on the input image 510. Specifically, the auto-encoder model may extract the feature vector 520 from the input image 510 by performing encoding (or compressing) the input image 510 using only the plurality of encoders excluding the plurality of decoders. For example, the feature vector 520 may include a characteristic related to the defect type identified from the input image 510.

For example, the auto-encoder model may extract the feature vector 520 with a size of 6272×1 by performing encoding (or compression) on the input image 510 with a size of 224×224×3.

Here, the input image 510 may include the wafer image data for the plurality of wafers, and the auto-encoder model may extract a plurality of feature vectors 520 by performing encoding (or compression) on each of the input images 510 for the plurality of wafers.

According to an embodiment, the model learning module 410 may train the artificial intelligence model by obtaining a latest input image 510 every specific period (or every specific number of times). Accordingly, the wafer defect analysis device 100 according to the present disclosure may improve reliability of the defect analysis by including the artificial intelligence model that learns the latest wafer.

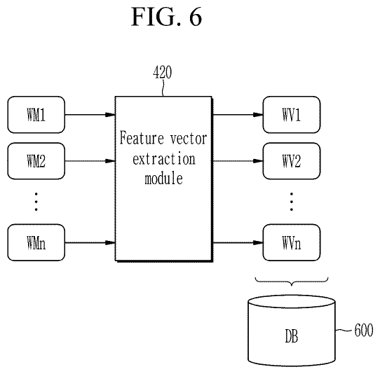

FIG. 6 is a view for describing an operation of the feature vector extraction module 420 according to one or more embodiments.

Referring to FIG. 6, the feature vector extraction module 420 according to the embodiment may extract feature vectors WV1-WVn from wafer maps WM1-WMn using the artificial intelligence model trained by the model learning module 410. Here, n may be any natural number.

For example, the feature vector extraction module 420 may use the artificial intelligence model to extract the first feature vector WV1 from the first wafer map WM1, to extract the second feature vector WV2 from the second wafer map WM2, and to extract the nth feature vector WVn from the nth wafer map WMn.

According to an embodiment, each of the feature vectors WV1-WVn may indicate information on a defect included in each of the wafer maps WM1-WMn. For example, the first feature vector WV1 may indicate information on a defect included in the first wafer map WM1, the second feature vector WV2 may indicate information on a defect included in the second wafer map WM2, and the nth feature vector WVn may indicate information on a defect included in the nth wafer map WMn.

According to an embodiment, a database 600 may be updated based on at least some of the feature vectors WV1-WVn extracted from the wafer maps WM1-WMn by the feature vector extraction module 420. Specifically, the database 600 related to the defect type of the wafer may be updated based on the at least some of the feature vectors WV1-WVn extracted by the feature vector extraction module 420.

The database 600 may include the feature vectors WV1-WVn for wafers that include defects among the measured wafers. Each of the feature vectors WV1-WVn may be managed together with information on the defect type corresponding thereto.

According to an embodiment, the feature vector extraction module 420 may perform an extraction operation on the wafer maps WM1-WMn every specific period (or every specific number of times). Accordingly, the database 600 may be updated every specific period (or every specific number of times).

As described above, the wafer defect analysis device 100 according to the present disclosure may improve accuracy and reliability of the defect analysis of the wafer using the database 600 that is updated every specific period (or every specific number of times).

The feature vector extraction module 420 according to the embodiment may extract the feature vector extracted from the image data of the wafer that is the object of the defect analysis. In the present disclosure, the feature vector extracted from the image data of the wafer that is the object of the defect analysis may be referred to as the target vector.

According to an embodiment, the feature vector extraction module 420 may extract the target vector from the wafer image data obtained from a cloud server, a web storage, or an external storage device (e.g., an external database or an external memory card).

According to an embodiment, the feature vector extraction module 420 may extract the target vector from the wafer image data using the trained artificial intelligence model. For example, the feature vector extraction module 420 may extract the target vector from the wafer image data using the auto-encoder model.

According to an embodiment, the target vector may not be stored in the database 600 where the feature vectors WV1-WVn are stored. However, the present disclosure is not limited thereto, and the target vector may also be stored in the database 600.

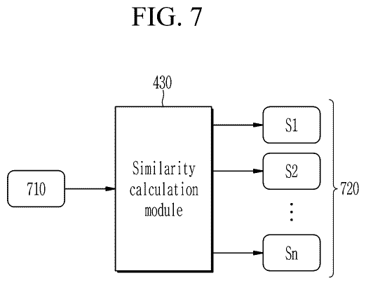

FIG. 7 is a view for describing an operation of the similarity calculation module 430 according to one or more embodiments.

Referring to FIG. 7, the similarity calculation module 430 according to the embodiment may perform similarity analysis between a target vector 710 of the wafer that is the object of the defect analysis and a reference vector 720 included in the database. The similarity calculation module 430 may perform similarity analysis between the target vector 710 and each of a plurality of reference vectors S1-Sn included in the database.

According to an embodiment, the similarity calculation module 430 may calculate a similarity between the target vector 710 and the reference vector 720 based on a variable of the target vector 710 and a variable of the reference vector 720. Specifically, the similarity calculation module 430 may calculate a similarity between the target vector 710 and each of the plurality of reference vectors S1-Sn based on the variable of the target vector 710 and a variable of each of the plurality of reference vectors S1-Sn.

According to an embodiment, the similarity calculation module 430 may determine that the similarity between the target vector 710 and the reference vector 720 is greater as the variable of the target vector 710 and the variable of the reference vector 720 are similar to each other. For example, if it is determined that a similarity between the variable of the target vector 710 and the variable of the first reference vector S1 is greater than a similarity between the variable of the target vector 710 and the variable of the second reference vector S2, the similarity calculation module 430 may determine that the similarity between the target vector 710 and the first reference vector S1 is greater than the similarity between the target vector 710 and the second reference vector S2.

According to an embodiment, the similarity calculation module 430 may calculate a distance between the target vector 710 and each of the plurality of reference vectors S1-Sn based on the variable of the target vector 710 and the variable of each of the plurality of reference vectors S1-Sn.

According to an embodiment, the similarity calculation module 430 may determine that the similarity between the target vector 710 and the reference vector 720 is greater as a distance between the target vector 710 and the reference vector 720 is smaller. For example, if it is determined that a first distance between the target vector 710 and the first reference vector S1 is less than a second distance between the target vector 710 and the second reference vector S2, the similarity calculation module 430 may determine that the similarity between the target vector 710 and the first reference vector S1 is greater than the similarity between the target vector 710 and the second reference vector S2.

According to an embodiment, the similarity calculation module 430 may calculate a cosine similarity between the target vector 710 and each of the plurality of reference vectors S1-Sn based on the variable of the target vector 710 and the variable of each of the plurality of reference vectors S1-Sn.

According to an embodiment, the similarity calculation module 430 may determine that the similarity between the target vector 710 and the reference vector 720 is greater as a cosine similarity between the target vector 710 and the reference vector 720 is greater. For example, if it is determined that the cosine similarity between the target vector 710 and the first reference vector S1 is greater than the cosine similarity between the target vector 710 and the second reference vector S2, the similarity calculation module 430 may determine that the similarity between the target vector 710 and the first reference vector S1 is greater than the similarity between the target vector 710 and the second reference vector S2.

According to an embodiment, the similarity calculation module 430 may analyze the similarity between the reference vector 720 and the target vector 710 to quantify the similarity. The similarity calculation module 430 may analyze the similarity between the target vector 710 and each of the plurality of reference vectors S1-Sn to quantify the similarity.

According to an embodiment, it may be determined that the similarity between the target vector 710 and each of the plurality of reference vectors S1-Sn is greater as a value of the similarity is higher. For example, if the similarity value for the first reference vector S1 is greater than the similarity value for the second reference vector S2, it may be determined that the similarity between the target vector 710 and the first reference vector S1 is greater than the similarity between the target vector 710 and the second reference vector S2.

FIG. 8 is a view for describing a similarity calculation method of the similarity calculation module 430 according to one or more embodiments.

Referring to FIG. 8, the similarity calculation module 430 may generate wafer vectors based on the first to nth variables a11 to akn. k and n may be natural numbers. For example, the similarity calculation module 430 may generate the first wafer vector W1v and the second wafer vector W2v based on the first variable a11, the second variable a12, the third variable a21, and the fourth variable a22.

Here, the first wafer vector W1v may correspond to the target vector, and the second wafer vector W2v may correspond to one of the plurality of reference vectors.

According to an embodiment, the first wafer vector W1v and the second wafer vector W2v may be expressed in terms of a first variable a1 and a second variable a2. The first wafer vector W1v may have a vector value for the first variable a11 and the second variable a12, and the second wafer vector W2v may have a vector value for the third variable a21 and the fourth variable a22. Here, the first wafer vector W1v may correspond to data on the defect of the wafer that is the object of the defect analysis, and the second wafer vector W2v may correspond to data on the defect of the wafer that is an object of comparison. That is, the similarity calculation module 430 may calculate a similarity between the first and second wafer vectors W1v and W2v for the wafer that is the object of the defect analysis and the wafer that is the object of comparison.

According to an embodiment, the similarity calculation module 430 may calculate a first distance D1 between the first wafer vector W1v and the second wafer vector W2v. The first distance D1 may be expressed by the following Equation 3.

$$D 1 = \sqrt{{( a 11 - a 21 )}^{2} + {( a 12 - a 22 )}^{2}} \qquad ( Equation 3 )$$

According to an embodiment, the similarity calculation module 430 may determine that the similarity between the first wafer vector W1v and the second wafer vector W2v is greater as the distance between the first wafer vector W1v and the second wafer vector W2v is smaller.

According to an embodiment, the similarity calculation module 430 may calculate a cosine similarity between the first wafer vector W1v and the second wafer vector W2v. A first angle θ1 may correspond to an angle between the first wafer vector W1v and the second wafer vector W2v. The first angle θ1 may be expressed by the following Equation 4.

$$cos θ1 = \frac{w 1 v \cdot w 2 v}{\vert w 1 v \vert \cdot \vert w 2 v \vert} \qquad ( Equation 4 )$$

According to an embodiment, the similarity calculation module 430 may determine that the similarity between the first wafer vector W1v and the second wafer vector W2v is greater as the first angle θ1 between the first wafer vector W1v and the second wafer vector W2v is smaller.

In other words, if a characteristic of the wafer that is the object of the defect analysis is similar to a characteristic of the wafer that is the object of comparison, the first angle θ1 may be small.

According to an embodiment, the similarity calculation module 430 may determine that the cosine similarity between the first wafer vector W1v and the second wafer vector W2v is higher as the first angle θ1 between the first wafer vector W1v and the second wafer vector W2v is smaller.

According to an embodiment, the similarity calculation module 430 may determine that the similarity between the first wafer vector W1v and the second wafer vector W2v is greater as the cosine similarity between the first wafer vector W1v and the second wafer vector W2v is greater.

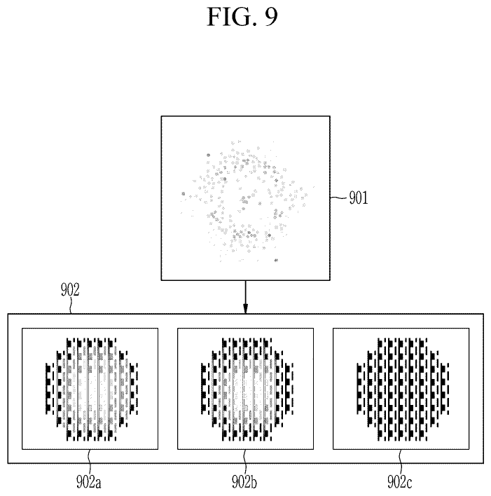

FIG. 9 is a view for describing that the wafer defect analysis device according to the one or more embodiments provides a defect analysis result.

Referring to FIG. 9, the wafer defect analysis device 100 according to the embodiment may display a graphical user interface (GUI) indicating a result of the similarity analysis based on a result of calculating the similarity between the feature vectors (e.g., the target vector and the reference vector).

According to an embodiment, the wafer defect analysis device 100 may provide reference maps 902 corresponding to the reference vector through the display 140 based on the result of calculating the similarity between the feature vectors (e.g., the target vector and the reference vector).

Specifically, the wafer defect analysis device 100 according to the embodiment may display the reference maps 902 within the database aligned (or listed) in an order in which the reference maps are similar to a target map 901.

For example, a first similarity between the first reference map 902a and the target map 901 may be greater than a second similarity between the second reference map 902b and the target map 901, and the second similarity may be greater than a third similarity between the third reference map 902c and the target map 901. However, the present disclosure is not limited thereto, and for example, the third similarity may be greater than the first similarity.

According to an embodiment, the first to third reference maps 902a, 902b, and 902c may be the reference maps clustered into the same cluster by the K-means clustering method.

In other words, the first similarity, the second similarity, and the third similarity may have similar values.

As described above, the wafer defect analysis device 100 according to the present disclosure may improve convenience of a user analyzing the defect type by providing the reference map 902 similar to the target map 901 through the display 140.

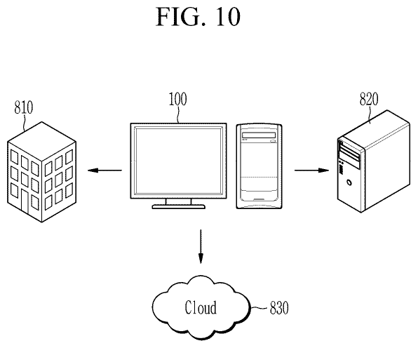

FIG. 10 is a view for describing that the wafer defect analysis device 100 according to the one or more embodiments transmits the database to the outside.

Referring to FIG. 10, the wafer defect analysis device 100 may transmit the database related to the defect type of the wafer to at least one of an external electronic device 810, a server 820, and a cloud computing system 830 through a communication interface (e.g., the communication interface 130 of FIG. 2). The cloud computing system 830 may refer to a network or a distributed collection of remote servers that store, process, and manage data for other devices and computers. The processor 110 may extract a plurality of feature vectors from the wafer map using the artificial intelligence model, and may transmit the database updated based on the extracted plurality of feature vectors to the at least one of the external electronic device 810, the server 820, and the cloud computing system 830.

The communication interface 130 according to an embodiment may include a short-range communication interface, a wired communication interface, a mobile communication interface, a broadcasting receiving module, and the like.

According to an embodiment, the database transmitted to the external electronic device 810, the server 820, or the cloud computing system 830 may be used to perform subsequent defect analysis of the semiconductor wafer. For example, the database may include one or more reference maps (or one or more reference vectors) for each of various defect types of the semiconductor wafer, and may be used to classify or analyze the defect type corresponding to the target map (or the target vector) by detecting the reference map (or the reference vector) matching or similar to the target map (or the target vector) in a defect analysis operation of the wafer.

In other words, when subsequent defect analysis of the semiconductor wafer is performed, the wafer defect analysis device 100 may obtain the database including the reference maps (or the reference vectors) from the external electronic device 810, the server 820, or the cloud computing system 830 to use the obtained database in order to classify or analyze the defect type corresponding to the target map (or the target vector).

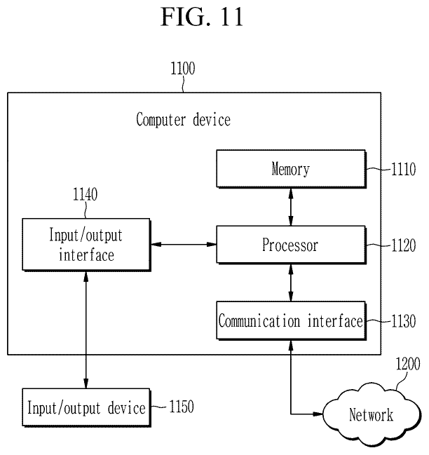

FIG. 11 is a view for describing an example of a computer device implementing an electronic device according to one or more embodiments. The wafer defect analysis device 100 of FIG. 1 may be implemented by the computer device 1100 shown in FIG. 11.

Referring to FIG. 11, the computer device 1100 may include a memory 1110, a processor 1120, a communication interface 1130, and an input/output interface 1140.

The memory 1110 may be a computer-readable recording medium, and may include a permanent mass storage device such as a random access memory (RAM), a read only memory (ROM), or a disk drive. An operating system and at least one program code may be stored in the memory 1110. The software components may be loaded into the memory 1110 from a computer-readable recording medium separate from the memory 1110. The separate computer-readable recording medium may include a computer-readable recording medium such as a hard disk, a flash memory, an optical disk, or an external hard disk. Additionally, the software components may be loaded into the memory 1110 via the communication interface 1130.

The processor 1120 may be configured to process commands of a computer program by performing basic arithmetic, logic, and input/output operations. The commands may be provided to the processor 1120 by the memory 1110 or the communication interface 1130.

The communication interface 1130 may provide a function for the computer device 1100 to communicate with another device through a network 1200. The communication method is not limited, and may include not only a communication method utilizing the network 1200 (e.g., a mobile communication network, a wired Internet, a wireless Internet, or a broadcasting network) but also a short-range wireless communication between devices. For example, the network 1200 may include any one or more networks such as a personal area network (PAN), a local area network (LAN), a campus area network (CAN), a metropolitan area network (MAN), a wide area network (WAN), a broadband network (BBN), and Internet. The network 1200 may include any one or more of network topologies including a bus network, a star network, a ring network, a mesh network, a star-bus network, a tree or a hierarchical network, and the like, but the present disclosure is not limited thereto.

The input/output interface 1140 may serve as an interface capable of transferring a command or data input from a user or an input/output device 1150 to other component(s) of the computer device 1100. Additionally, the input/output interface 1140 may output a command or data received from other component(s) of the computer device 1100 to the user or the input/output device 1150. For example, the input/output device 1150 may include an input device such as a microphone, a keyboard, or a mouse, and an output device such as a display or a speaker.

The embodiments described above may be implemented in a form of a computer program that may be executed through various components on a computer, and the program may be recorded on a computer readable medium. The medium may include a magnetic media such as a hard disk, a floppy disk, and a magnetic tape, an optical recording media such as a CD-ROM and a DVD, and a hardware device specifically configured to store and execute a program command such as a ROM, a RAM, or a flash memory.

If the steps constituting the method according to the embodiment are not explicitly stated or stated contrary to the steps, the steps may be performed in a suitable order. The present disclosure is not necessarily limited to an order of description of the steps.

While this disclosure has been described in connection with what is presently considered to be practical embodiments, it should be understood that the disclosure is not limited to the disclosed embodiments, but, on the contrary, is intended to cover various modifications and equivalent arrangements included within the spirit and scope of the appended claims.

What is claimed is:

1. A wafer defect analysis device, comprising:
a memory that stores reference information according to a type of a wafer, an artificial intelligence model configured to extract a feature vector from image data, and a database related to a defect type of the wafer; and
at least one processor that is operationally connected to the memory and is configured to:
obtain manufacturing process data related to a manufacturing process of a reference wafer;
generate reference wafer image data based on the reference information and the manufacturing process data;
update the database based on a plurality of reference feature vectors extracted from the reference wafer image data using the artificial intelligence model;
perform similarity analysis between a target feature vector extracted from target wafer image data of a target wafer and the plurality of reference feature vectors included in the updated database; and
analyze a defect type of the target wafer based on a result of the similarity analysis.

2. The wafer defect analysis device of claim 1, further comprising a communication interface,
wherein the at least one processor is further configured to:
receive, through the communication interface, the manufacturing process data from at least one measurement device that measures the reference wafer on which at least one unit process in semiconductor manufacturing is performed.

3. The wafer defect analysis device of claim 1, wherein the reference information comprises:
predetermined chip coordinate information according to the type of the wafer; and
predetermined defect coordinate information indicating a location of a defect within the chip according to the type of the wafer, and
wherein the manufacturing process data comprises:
chip coordinate information of a chip included in the reference wafer; and
defect coordinate information indicating a location of a defect within the chip of the reference wafer.

4. The wafer defect analysis device of claim 1, wherein the wafer image data is scaled to a reference size for training the artificial intelligence model.

5. The wafer defect analysis device of claim 1, wherein the at least one processor is further configured to remove a noise from the reference wafer image data before the artificial intelligence model is trained.

6. The wafer defect analysis device of claim 1, wherein the artificial intelligence model comprises an auto-encoder model, and
wherein the at least one processor is further configured to extract the plurality of reference feature vectors and the target feature vector using the auto-encoder model.

7. The wafer defect analysis device of claim 1, wherein the at least one processor is further configured to:
calculate a cosine similarity between the target feature vector and each of the plurality of reference feature vectors or a distance between the target feature vector and each of the plurality of reference feature vectors, and
perform the similarity analysis based on the calculated cosine similarity or the calculated distance.

8. The wafer defect analysis device of claim 7, wherein the at least one processor is further configured to:
align the plurality of reference feature vectors included in the database in descending or ascending order of similarity, based on the result of the similarity analysis.

9. The wafer defect analysis device of claim 8, wherein the at least one processor is further configured to:
cluster the plurality of reference feature vectors aligned in the descending or ascending order of similarity using a K-means clustering method.

10. The wafer defect analysis device of claim 1, further comprising a display,
wherein the at least one processor is further configured to display a graphical user interface (GUI) indicating the result of the similarity analysis through the display.

11. The wafer defect analysis device of claim 1, wherein the at least one processor is further configured to transmit the updated database to at least one of an external electronic device, a server, and a cloud computing system via the communication interface.

12. An operating method of a wafer defect analysis device, the operating method comprising:
obtaining manufacturing process data related to a manufacturing process of a reference wafer;
generating reference wafer image data based on reference information according to a type of a wafer and the manufacturing process data;
updating a database based on a plurality of reference feature vectors extracted from the reference wafer image data using an artificial intelligence model configured to extract a feature vector from image data;
performing similarity analysis between a target feature vector extracted from target wafer image data of a target wafer and the plurality of reference feature vectors included in the updated database; and
analyzing a defect type of the target wafer based on a result of the similarity analysis.

13. The operating method of claim 12, wherein the obtaining of the manufacturing process data comprises receiving, through a communication interface of the wafer defect analysis device, the manufacturing process data from at least one measurement device that measures the reference wafer on which at least one unit process in semiconductor manufacturing is performed.

14. The operating method of claim 12, wherein the reference information comprises:
predetermined chip coordinate information of a chip according to a wafer type; and
predetermined defect coordinate information indicating a location of a defect within the chip according to the wafer type, and
wherein the manufacturing process data comprises:
chip coordinate information of a chip included in the reference wafer; and
defect coordinate information including a location of a defect within the chip of the reference wafer.

15. The operating method of claim 12, further comprising removing a noise from the reference wafer image data before the artificial intelligence model is trained.

16. The operating method of claim 12, wherein the performing of the similarity analysis comprises:
calculating a cosine similarity between the target feature vector and each of the plurality of reference feature vectors or a distance between the target feature vector and each of the plurality of reference feature vectors; and
performing the similarity analysis based on the calculated cosine similarity or the calculated distance.

17. The operating method of claim 16, further comprising aligning the plurality of reference feature vectors in descending or ascending order of similarity, based on the result of the similarity analysis.

18. The operating method of claim 17, further comprising clustering the plurality of reference feature vectors aligned in the descending or ascending order of similarity using a K-means clustering method.

19. The operating method of claim 12, further comprising displaying a graphical user interface (GUI) indicating the result of the similarity analysis through a display.

20. A wafer defect analysis system, comprising:
at least one measurement device configured to measure a reference wafer on which at least one unit process in semiconductor manufacturing is performed; and
a wafer defect analysis device configured to analyze a defect type of a wafer based on manufacturing process data of the reference wafer received from the at least one measurement device,
wherein the wafer defect analysis device comprises at least one processor configured to:
extract a feature vector from image data;
generate reference wafer image data based on the manufacturing process data of the reference wafer;
extract a plurality of reference feature vectors related to a defect of the reference wafer from the reference wafer image data, using an artificial intelligence model; and
perform similarity analysis between a target feature vector extracted from target wafer image data of a target wafer and the plurality of reference feature vectors; and
analyze a defect type of the target wafer based on a result of the similarity analysis.
